(19) United States
(12) Patent Application Publication
(10) Pub. No.: US 2012/0102910 A1
(43) Pub. Date: May 3, 2012

(54) High Flow Eductor

(75) Inventors: Jay M. Francisco, Chula Vista, CA (US); Jack V. Vitale, San Diego, CA (US)

(73) Assignee: Hamilton Sundstrand Corporation, Windsor Locks, CT (US)

(21) Appl. No.: 12/916,067

(22) Filed: Oct. 29, 2010

(51) Int. Cl. F02C 7/00

(52) U.S. Cl. 60/39.5

(57) ABSTRACT

An exhaust eductor for a gas turbine engine comprises: an engine exhaust chamber with an exhaust chamber inlet that receives engine exhaust from the gas turbine engine and an exhaust chamber outlet that discharges the engine exhaust to establish an exhaust gas flow through the engine exhaust chamber; an air chamber with an air inlet that receives ambient air external to the gas turbine engine; and a mixing baffle that couples the air chamber to the engine exhaust chamber, comprising a first side adjacent the air chamber, a second side adjacent the exhaust chamber, multiple apertures through the mixing baffle that extend from the first side to the second side of the mixing baffle, each aperture having a corresponding canopy that extends from an upstream end of the aperture along the second side of the mixing baffle into the exhaust gas flow for at least a portion of the length of the aperture, to establish an air flow from the air inlet of the air chamber into the exhaust gas flow.

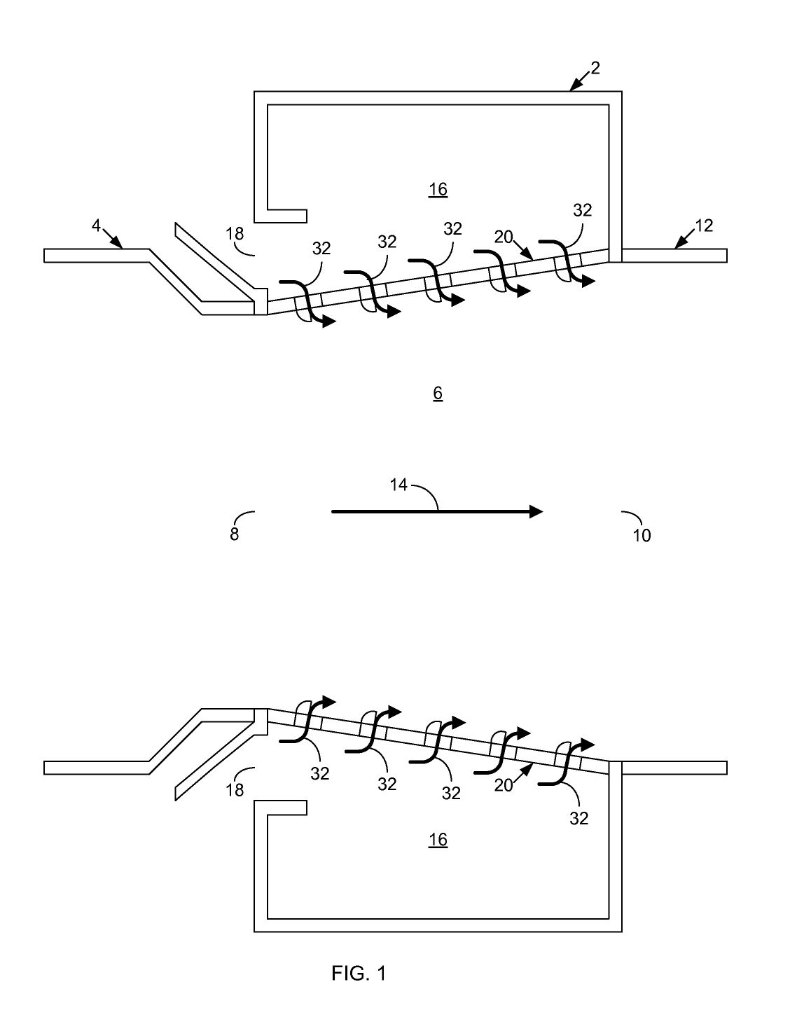

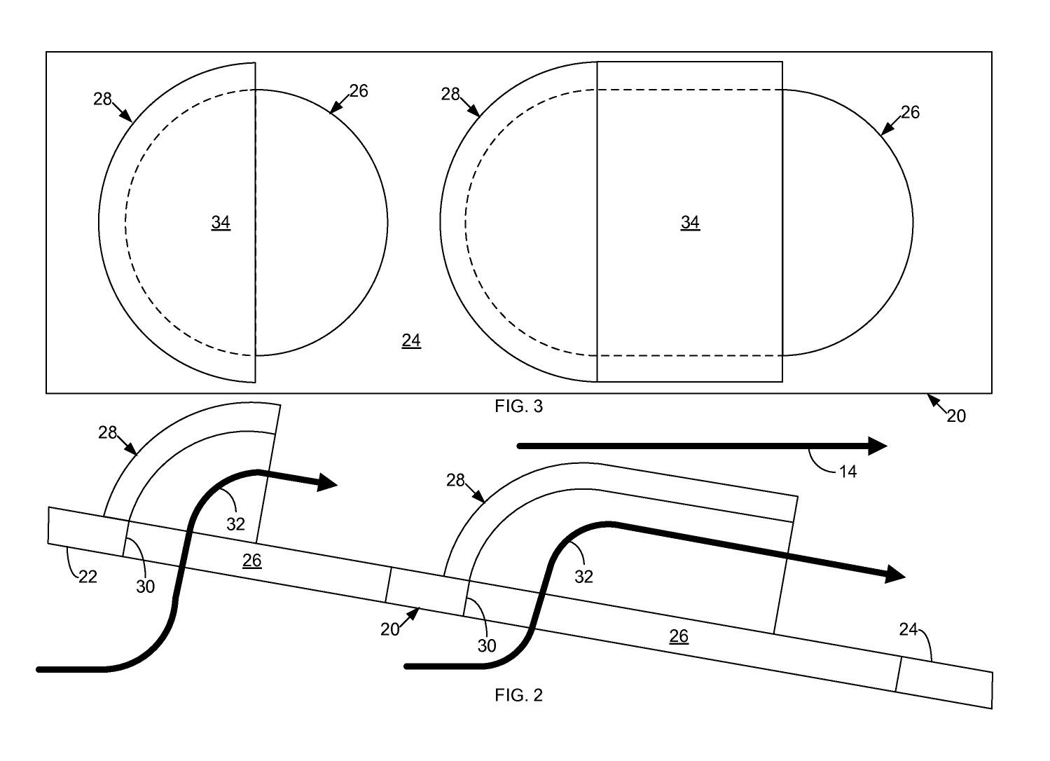

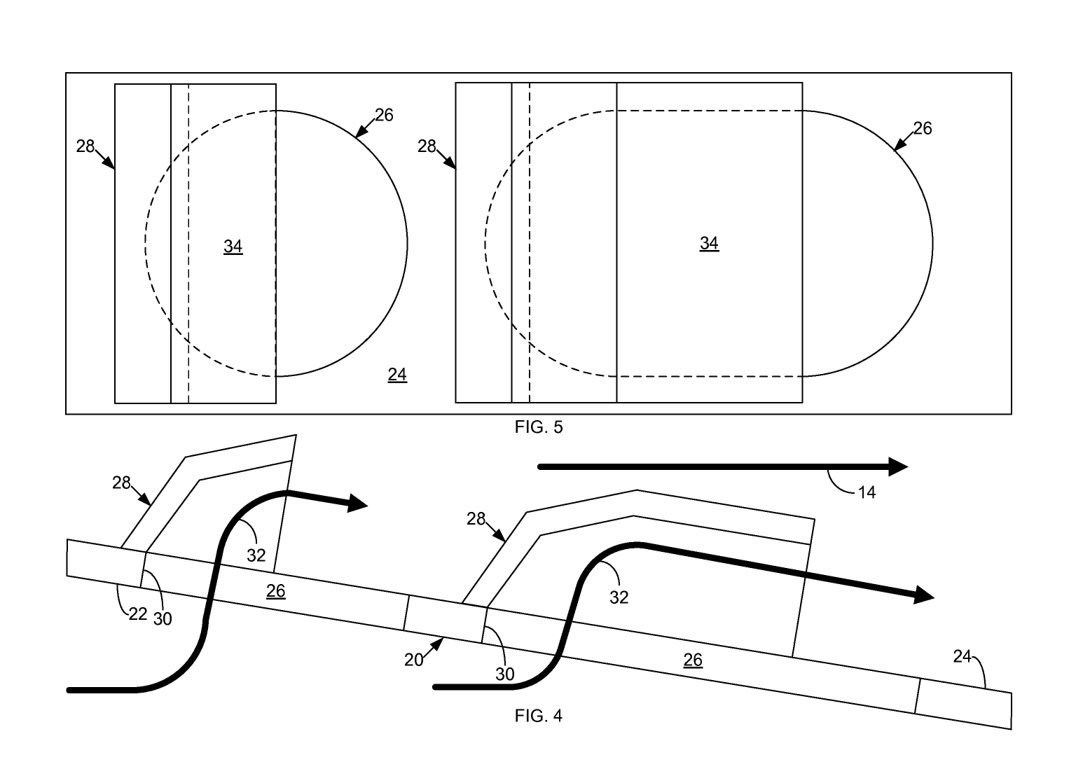

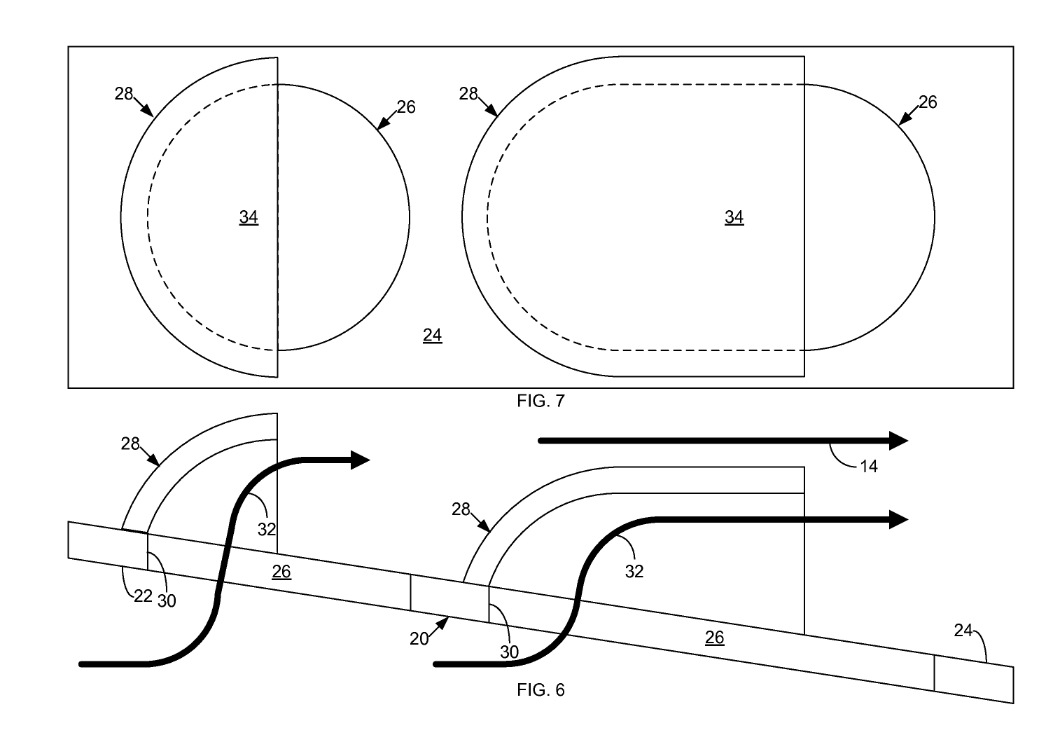

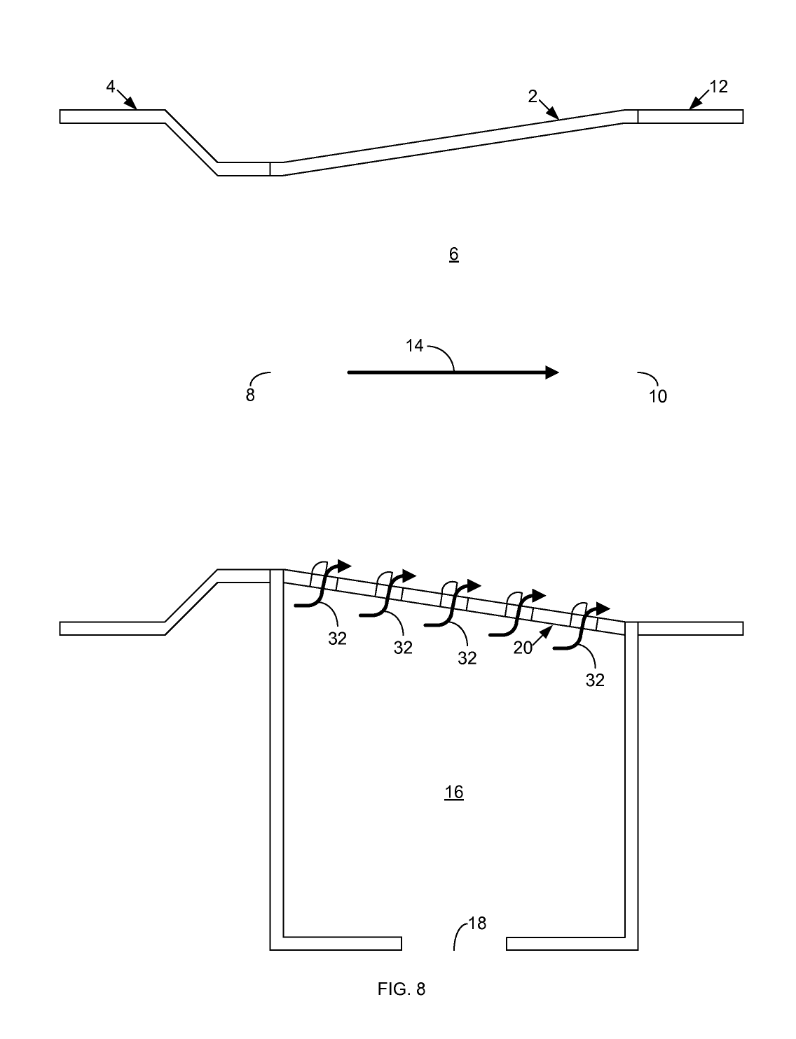

FIG. 1 is a cut-away side view of an eductor for a gas turbine engine according to a first possible embodiment of the invention. FIG. 2 is a partial cut-away side view of a mixing baffle for the eductor shown in FIG. 1 that has apertures and corresponding curvilinear canopies that have a first canopy roof arrangement. FIG. 3 is a partial cut-away top view of a mixing baffle for the eductor shown in FIG. 1 that has apertures and corresponding curvilinear canopies that have a first canopy roof arrangement. FIG. 4 is a partial cut-away side view of a mixing baffle for the eductor shown in FIG. 1 that has apertures and corresponding curvilinear canopies that have a second canopy roof arrangement. FIG. 5 is a partial cut-away top view of a mixing baffle for the eductor shown in FIG. 1 that has apertures and corresponding curvilinear canopies that have a second canopy roof arrangement. FIG. 6 is a partial cut-away side view of a mixing baffle for the eductor shown in FIG. 1 that has apertures and corresponding rectilinear canopies. FIG. 7 is a partial cut-away top view of a mixing baffle for the eductor shown in FIG. 1 that has apertures and corresponding rectilinear canopies. FIG. 8 is a cut-away side view of an eductor for a gas turbine engine according to a second possible embodiment of the invention.

FIG. 1 is a side view of an eductor 2 for a gas turbine engine 4 according to a first possible embodiment of the invention. The eductor 2 may replace the exhaust silencer or eductor assembly described in U.S. Pat. No. 7,578,369, hereby incorporated by reference.

The eductor 2 has an exhaust chamber 6 with an exhaust chamber inlet 8 that receives engine exhaust from the gas turbine engine 4 and an exhaust chamber outlet 10 that discharges the engine exhaust to an exhaust pipe 12 to establish an exhaust gas flow through the engine exhaust chamber with an axis of exhaust gas flow represented by arrow 14. The eductor 2 also has an air chamber 16 with an air inlet 18 that receives ambient air external to the gas turbine engine 4. The air chamber 16 surrounds the exhaust chamber 6 between the exhaust chamber inlet 8 and the exhaust chamber outlet 10.

A mixing baffle 20 couples the air chamber 16 to the exhaust chamber 6. In this embodiment, the mixing baffle 20 forms a surface of revolution relative to the axis of exhaust gas flow 14, and more specifically resembles a generally truncated cone with its base adjacent the exhaust chamber outlet 10. The effective aperture of the surface of revolution that the mixing baffle 20 forms should be greater than zero degree and less than ninety degrees, with the range of approximately ten to forty degrees most suitable. The mixing baffle 20 has a first side 22 adjacent the air chamber 16 and a second side 24 adjacent the exhaust chamber 6.

Referring to FIGS. 1, 2 and 3 together, the mixing baffle 20 has multiple apertures 26 through the mixing baffle 20 that extend from the first side 22 of the mixing baffle 20 to the second side 24 of the mixing baffle 20. The apertures 26 may be round, have a generally oval or slotted shape or any shape that promotes increased air flow effectiveness and the mixing baffle 20 may have a mixture thereof. FIGS. 2 and 3 show apertures 26 with both round and oval shapes. Each aperture 26 has a corresponding canopy 28 that extends from an upstream end 30 of the aperture 26 along the second side 24 of the mixing baffle 20 into the exhaust gas flow for at least a portion of the length of the aperture 26 to establish an air flow from the air inlet 18 of the air chamber 16 into the exhaust gas flow within the exhaust chamber 6, as represented by arrows 32. Each canopy 28 causes lower static pressure to appear at its corresponding aperture 26, thereby increasing velocity of the air flow 32 through its corresponding aperture 26.

Each canopy 28 has a roof 34, its height of which above the second side 24 of the mixing baffle 20 may also affect static pressure that appears at its corresponding aperture 26 and thereby affecting velocity of the air flow 32 through its aperture 26. Different apertures 26 may also have corresponding canopies 28 along the mixing baffle 20 that have roofs of different height above the second side 24 of the mixing baffle 20. Furthermore, referring to FIGS. 4 and 5 together, the roof 34 of each canopy 28 may be generally parallel to the axis of exhaust gas flow 14 instead of generally parallel to the second side 24 of the mixing baffle 20 as shown in FIGS. 2 and 3. Additionally, referring to FIGS. 6 and 7 together, each canopy 28 may be generally rectilinear instead of curvilinear as shown in FIGS. 2 through 5.

FIG. 8 is a side view of the eductor 2 for the gas turbine engine 4 according to a second possible embodiment of the invention. In this embodiment, the air chamber 16 is adjacent to the exhaust chamber 6. The mixing baffle 20 is generally planar and mounts between the air chamber 16 and the exhaust chamber 6 so that its downstream length along the direction of the exhaust gas flow tilts away from the axis of exhaust gas flow 14 to form an oblique angle with the axis of exhaust gas flow 14. The oblique angle that the downstream length of the mixing baffle 20 forms should be greater than zero degree and less than forty-five degrees, with the range of approximately five to twenty degrees most suitable. Any of the apertures 26 and canopies 28 as described in connection with FIGS. 2 through 7 are suitable for this embodiment.

The described embodiments as set forth herein represents only some illustrative implementations of the invention as set forth in the attached claims. Changes and substitutions of various details and arrangement thereof are within the scope of the claimed invention.

1. An exhaust eductor for a gas turbine engine, comprising:
an exhaust chamber with an exhaust chamber inlet that receives engine exhaust from the gas turbine engine and an exhaust chamber outlet that discharges the engine exhaust to establish an exhaust gas flow through the exhaust chamber;
an air chamber with an air inlet that receives ambient air external to the gas turbine engine; and
a mixing baffle that couples the air chamber to the exhaust chamber, comprising a first side adjacent the air chamber, a second side adjacent the exhaust chamber, multiple apertures through the mixing baffle that extend from the first side to the second side of the mixing baffle, each aperture having a corresponding canopy that extends from an upstream end of the aperture along the second side of the baffle into the exhaust gas flow for at least a portion of the length of the aperture, to establish an air flow from the air inlet of the air chamber into the exhaust gas flow.

2. The exhaust eductor of claim 1, wherein the apertures in the mixing baffle are generally round.

3. The exhaust eductor of claim 2, wherein each canopy extends for approximately half of the length of its corresponding aperture.

4. The exhaust eductor of claim 1, wherein the apertures in the mixing baffle are generally oval.

5. The exhaust eductor of claim 4, wherein each canopy extends for more than half of the length of its corresponding aperture.

6. The exhaust eductor of claim 1, wherein a roof of the canopy is generally parallel to the second side of the mixing baffle.

7. The exhaust eductor of claim 1, wherein a roof of the canopy is generally parallel to an axis of the exhaust gas flow.

8. The exhaust eductor of claim 1, wherein the mixing baffle forms a surface of revolution relative to an axis of the exhaust gas flow.

9. The exhaust eductor of claim 8, wherein the mixing baffle resembles a generally truncated cone.

10. The exhaust eductor of claim 1, wherein the mixing baffle is generally planar.

11. The exhaust eductor of claim 11, wherein the mixing baffle has an oblique tilt relative to an axis of the exhaust gas flow.

12. The exhaust eductor of claim 1, wherein the canopy is generally curvilinear.

13. The exhaust eductor of claim 1, wherein the canopy is generally rectilinear.

14. A mixing baffle for an exhaust eductor used with a gas turbine engine to combine ambient air along a first side of the mixing baffle with exhaust gas flow along a second side of the mixing baffle, comprising:
multiple apertures through the mixing baffle that extend from the first side to the second side of the mixing baffle; and
a canopy for each aperture that extends from an upstream end of the aperture along the second side of the mixing baffle into the exhaust gas flow for at least a portion of the length of the aperture.

15. The mixing baffle of claim 14, wherein the apertures are generally round.

16. The mixing baffle of claim 15, wherein each canopy extends for approximately half of the length of its corresponding aperture.

17. The mixing baffle of claim 14, wherein the apertures are generally oval.

18. The mixing baffle of claim 17, wherein each canopy extends for more than half of the length of its corresponding aperture.

19. The mixing baffle of claim 14, wherein a roof of the canopy is generally parallel to the second side of the mixing baffle.

20. The mixing baffle of claim 14, wherein a roof of the canopy is generally parallel to an axis of the exhaust gas flow.

21. The mixing baffle of claim 14, wherein the second side forms a surface of revolution relative to an axis of the exhaust gas flow.

22. The mixing baffle of claim 21, wherein the second side resembles a generally truncated cone.

23. The mixing baffle of claim 14, wherein the second side is generally planar.

24. The mixing baffle of claim 23, wherein the second side has an oblique tilt relative to an axis of the exhaust gas flow.

25. The mixing baffle of claim 14, wherein the canopy is generally curvilinear.

26. The mixing baffle of claim 14, wherein the canopy is generally rectilinear.
